(19) United States
(12) Patent Application Publication
(10) Pub. No.: US 2019/0337716 A1
(43) Pub. Date: Nov. 7, 2019

(54) Tash Receptacle Combination Trash Bag Dispenser

(71) Applicant: Michael J. Mollo, Budd Lake, NJ (US)

(72) Inventor: Michael J. Mollo, Budd Lake, NJ (US)

(73) Assignee: Michael J. Mollo, Budd Lake, NJ (US)

(21) Appl. No.: 15/969,673

(22) Filed: May 2, 2018

(51) Int. Cl. B65F 1/06; B65D 83/08

(52) U.S. Cl. CPC B65F 1/062; B65D 83/0805

(57) ABSTRACT

An improved trash receptacle combination trash bag dispenser. The trash bag dispenser is mounted on the upper back or lid of the trash can. This dispenser is designed to hold a roll of trash bags in an outer housing. The main compartment is comprised of two parts an outer and inner housing. The inner housing rotates within the outer housing on two pins which are snapped into the side of the inner housing creating inner cavity in which the roll of garbage bags will be inserted. Once assembled the inner housing rotates to its closed position but allowing the garbage bags to be extracted from the top edge which is not fully closed.

### BACKGROUND OF INVENTION

There have been numerous variations on this invention. Most are comprised of a device dispensing garbage bags from the bottom of the pail.

### THE FIELD OF INVENTION

Is continually active for example U.S. Pat. No. 3,451,453 issued on June 1969 involves dispensing from bottom of the garbage pail. Through U.S. Pat. No. 8,807,379 issued on Aug. 19, 2014. U.S. Pat. No. 4,823,979 issued on Apr. 25, 1989 shows a trash container combination with a roll of trash bags in a holding device near the top back of the garbage pail. But even this device dispenses the bags downward to the bottom of the garbage pail and then rotated on the spindle back upward this can only be used in a continuous connected roll of garbage bags not in a roll of unconnected garbage bags.

### SUMMARY OF INVENTION

The preferred embodiment of my invention is comprised of two parts, and outer housing and inner housing. The inner housing rotates within the outer housing on fixed pins, and creates a cavity in which a roll of garbage bags can be stored. When the inner housing is rotated to its locked position, it enables an individual garbage bag to be extracted one at a time, through an opening between in the outer an inner housing.

### SHORT DESCRIPTION OF THE DRAWINGS

FIG. 1 illustrates the outer housing of the trash bag dispenser. FIG. 2 illustrates the inner housing which rotates within the outer housing. FIG. 3 illustrates the inner and outer housing assembled with no bags installed. FIG. 4 illustrates the inner and outer housing assembled with a roll of trash bags installed in its open position. FIG. 5 illustrates the inner and outer housing assembled with a roll of trash bags installed in its closed and locked position. FIG. 6 illustrates the inner and outer housing assembled with a roll of garbage bags installed in its locked position mounted within the trash receptacle.

### DESCRIPTION OF PREFERRED EMBODIMENT

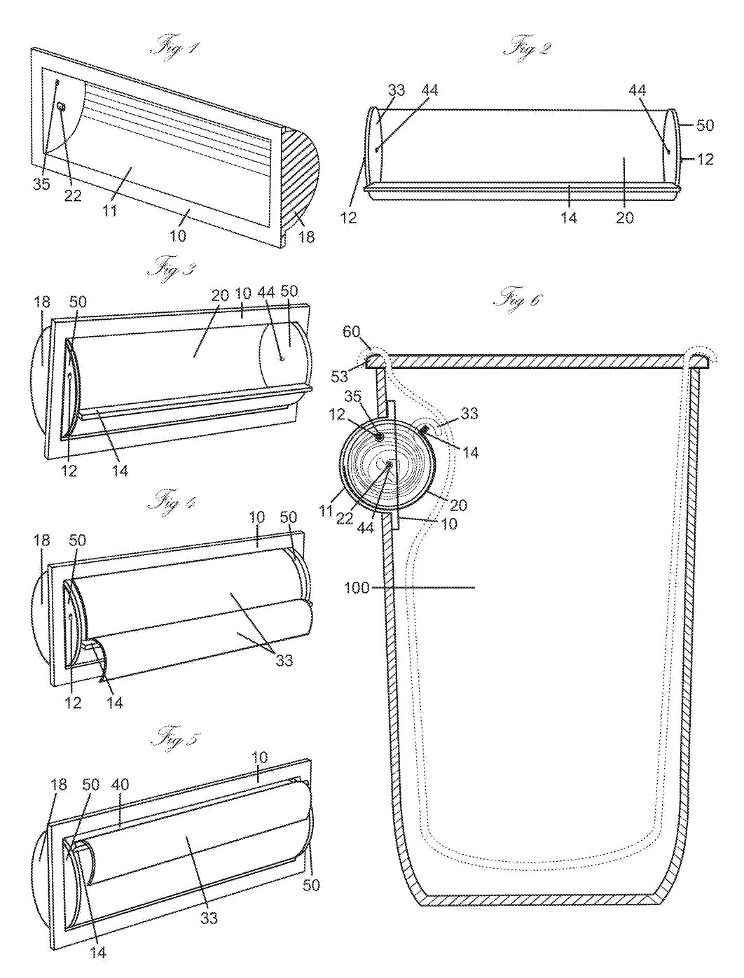

A trash bag dispenser and trash receptacle combination. FIG. 1 illustrates (11) the outer housing of the garbage bag dispenser. (22) connecting pin to connect (FIG. 2, 44) inner housing mounting holes. (35) detent for fixing the inner housing in its locked position (FIG. 2, 12). (18) sidewall of outer housing. (10) Outer housing flange. FIG. 2 illustrates (20) inner housing which rotates within the outer housing (50) outer housing sidewall (FIG. 1, 22) pins (FIG. 2, 44) hole that connect inner and outer housings. (14) inner housing handle which you grab to move from unlocked position to locked position and back to unlock the position for reloading. (50) sidewall of inner housing. (12) bump lock that positions inside of (FIG. 1, 35) to lock inner housing when rotated up. FIG. 3 Inner and Outer housing assembled and in the open position. (20) bump lock (44) hole to accept pin. (FIG. 1, 22) (10) Outer housing flange. (14) inner housing handle. (50) inner housing side. (18) outer housing side. (20) empty trash bag cavity. FIG. 4 Inner and Outer housing assembled and in the open position with a loaded roll of trash bags. (20) bump lock (44) hole to accept pin. (FIG. 1, 22) (10) Outer housing flange. (14) inner housing handle. (50) inner housing side. (18) outer housing side. (20) empty trash bag cavity. (33) roll of trash bags. FIG. 5 Inner and Outer housing assembled and in the closed and lock position with a loaded roll of trash bags. Dispenser ready to dispense bags. (10) Outer housing flange. (14) inner housing handle. (50) inner housing side. (18) outer housing side. (20) empty trash bag cavity. (33) roll of trash bags. FIG. 6 Assembled improved trash receptacle combination trash bag dispenser. (100) trash container with trash receptacle in closed position. (53) edge of trash receptacle. (60) in use trash bag with top of bag over (53) edge of trash receptacle. (10, 11, 12, 14, 20, 22, 35, 44) Assembled trash bag dispenser. (10) outer housing (11) outer housing radius (14) inner housing handle (20) inner housing radius (22) pin, outer housing. (44) inner housing mounting hole. (35) detent to accept bump lock. (12) bump lock in detent. (33) roll of trash bags.

1. A trash bag dispenser and trash receptacle combination. (a) where the receptacle is mounted to the upper back or the lid of the trash receptacle. (b) The dispenser having a rotatable closure that remains partially open when it is in its locked position. (c) Allowing the user easy access to the garbage bags.

2. The main structure of the trash receptacle when the lid is open, is to allow the trash bag to receive trash (a) the body of the trash receptacle is rectangular in shape with a cavity of a rigid bottom and sides. (b) the trash receptacle will also include a rigid top lid.

3. When fully open, the trash bag dispenser can be reloaded.
